(19) United States
(12) Patent Application Publication
(10) Pub. No.: US 2025/0233208 A1
(43) Pub. Date: Jul. 17, 2025

(54) ELECTROLYTE COMPOSITION FOR BATTERIES

(71) Applicant: GM Global Technology Operations LLC, Detroit, MI (US)

(72) Inventors: Chuanlong Wang, Troy, MI (US); Xiaosong Huang, Novi, MI (US); Umamaheswari Viswanathan, Troy, MI (US)

(21) Appl. No.: 18/410,017

(22) Filed: Jan. 11, 2024

(51) Int. Cl. H01M 10/0568; H01M 4/02; H01M 4/38; H01M 4/46; H01M 4/58; H01M 4/583; H01M 10/052; H01M 10/0567; H01M 10/0569

(52) U.S. Cl. CPC H01M 10/0568; H01M 4/382; H01M 4/463; H01M 4/5825; H01M 4/583; H01M 10/052; H01M 10/0567; H01M 10/0569; H01M 2004/027; H01M 2004/028; H01M 2300/0034; H01M 2300/0037

(57) ABSTRACT

An electrolyte composition for a battery includes a lithium salt dissolved in an organic solvent; and 0.01 to less than 1 weight percent of lithium 4,5-dicyano-2-(trifluoromethyl)imidazolide, lithium 4,5-dicyano-2-(pentafluoroethyl)imidazolide lithium 4,5-dicyano-2-(n-heptafluoropropyl)imidazolide), or a combination thereof, based on a total weight of the electrolyte composition.

### INTRODUCTION

The present disclosure relates to batteries and methods of forming the same. More particularly, the present disclosure relates to an electrolyte having improved electrochemical properties, and methods of making the same.

Battery cells may include an anode, a cathode, an electrolyte composition, and a separator. A battery cell may operate in charge mode, receiving electrical energy. A battery cell may operate in discharge mode, providing electrical energy. A battery cell may operate through charge and discharge cycles, where the battery first receives and stores electrical energy and then provides electrical energy to a connected system. In vehicles utilizing electrical energy to provide motive force, battery cells of the vehicle may be charged, and then the vehicle may navigate for a period of time, utilizing the stored electrical energy to generate motive force.

A battery cell includes an electrolyte composition which provides lithium-ion conduction paths between the anode and the cathode. The electrolyte is an ionic conductor. The electrolyte is additionally an electronically insulating material.

Hybrid electric and full electric (collectively “electric-drive”) powertrains take on various architectures, some of which utilize a battery system to supply power for one or more electric traction motors.

### SUMMARY

In one exemplary embodiment, the present disclosure provides an electrolyte composition for a battery, the electrolyte composition including a lithium salt dissolved in an organic solvent; and 0.01 to less than 1 weight percent of lithium 4,5-dicyano-2-(trifluoromethyl)imidazolide, lithium 4,5-dicyano-2-(pentafluoroethyl)imidazolide lithium 4,5-dicyano-2-(n-heptafluoropropyl)imidazolide), or a combination thereof, based on a total weight of the electrolyte composition.

In addition to one or more of the features described herein, the electrolyte composition may include 0.1 to 0.7 weight percent of the lithium 4,5-dicyano-2-(trifluoromethyl)imidazolide, lithium 4,5-dicyano-2-(pentafluoroethyl)imidazolide lithium 4,5-dicyano-2-(n-heptafluoropropyl)imidazolide), or the combination thereof, based on the total weight of the electrolyte composition.

In another exemplary embodiment, the lithium salt may include lithium hexafluorophosphate, lithium perchlorate, lithium tetrachloroaluminate, lithium iodide, lithium bromide, lithium thiocyanate, lithium tetrafluoroborate, lithium difluorooxalatoborate, lithium tetraphenylborate, lithium bis-(oxalate)borate, lithium tetrafluorooxalatophosphate, lithium nitrate, lithium hexafluoroarsenate, lithium trifluoromethanesulfonate, lithium bis(trifluoromethanesulfonimide), lithium fluorosulfonylimide, lithium fluoroalkylphosphate, or a combination thereof.

In yet another exemplary embodiment, the organic solvent may include a cyclic carbonate, a linear carbonate, an aliphatic carboxylic ester, a γ-lactone, a chain structure ether, a cyclic ether, a sulfur compound, or a combination thereof.

In yet another exemplary embodiment, the organic solvent may include ethylene carbonate, propylene carbonate, butylene carbonate, fluoroethylene carbonate, or a combination thereof; and dimethyl carbonate, diethyl carbonate, ethyl methyl carbonate, or a combination thereof.

In yet another exemplary embodiment, the electrolyte composition may include 1 to 10 weight percent of fluoroethylene carbonate, based on the total weight of the electrolyte composition; and 0.5 to 10 weight percent of vinylene carbonate, based on the total weight of the electrolyte composition.

In yet another exemplary embodiment, the lithium salt may include lithium hexafluorophosphate.

In yet another exemplary embodiment, the organic solvent may include ethylene carbonate and dimethyl carbonate in a volume ratio of 1:4 to 1:1.

In yet another exemplary embodiment, the electrolyte composition may include 0.1 to 0.7 weight percent of the lithium 4,5-dicyano-2-(trifluoromethyl)imidazolide, lithium 4,5-dicyano-2-(pentafluoroethyl)imidazolide lithium 4,5-dicyano-2-(n-heptafluoropropyl)imidazolide), or the combination thereof, based on the total weight of the electrolyte composition; the lithium salt may include lithium hexafluorophosphate; and the organic solvent may include 0.5 to 3 moles of the lithium hexafluorophosphate per 1 liter of the organic solvent, and ethylene carbonate and dimethyl carbonate in a volume ratio of 1:4 to 1:1.

In yet another exemplary embodiment, the electrolyte composition may further include 1 to 10 weight percent of fluoroethylene carbonate, based on the total weight of the electrolyte composition; and 0.5 to 10 weight percent of vinylene carbonate, based on the total weight of the electrolyte composition.

In yet another exemplary embodiment, the fluoroethylene carbonate may be present in an amount of 1 to 5 weight percent, based on the total weight of the electrolyte composition; and the vinylene carbonate may be present in an amount of 0.5 to 5 weight percent, based on the total weight of the electrolyte composition.

In one exemplary embodiment, the present disclosure provides a battery including an anode; a cathode; and an electrolyte composition including a lithium salt dissolved in an organic solvent, and 0.01 to less than 1 weight percent of lithium 4,5-dicyano-2-(trifluoromethyl)imidazolide, lithium 4,5-dicyano-2-(pentafluoroethyl)imidazolide lithium 4,5-dicyano-2-(n-heptafluoropropyl)imidazolide), or a combination thereof, based on a total weight of the electrolyte composition.

In addition to one or more of the features described herein, the anode may include silicon.

In another exemplary embodiment, the anode may include silicon monoxide, a lithium-doped silicon monoxide, or a combination thereof.

In yet another exemplary embodiment, the cathode may include nickel.

In yet another exemplary embodiment, the cathode may include Li₍₁₊ₓ₎Mn₂O₄, where 0.1≤x≤1; LiMn₍₂₋ₓ₎NiₓO₄, where 0≤x≤0.5; LiCoO₂; Li(NiₓMn_{y}Co_{z})O₂, where 0≤x≤1, 0≤y≤1, 0≤z≤1, and x+y+z=1; LiNi_{(1-x-y)}CoₓM_{y}O₂, where 0<x<0.2, y<0.2, and M is Al, Mg, or Ti; LiFePO₄, LiMn₂₋ₓFeₓPO₄, where 0<x<0.3; LiNiCoAlO₂; LiMPO₄, where M is at least one of Fe, Ni, Co, and Mn; Li(NiₓMn_{y}Co_{z}Alₚ)O₂, where 0≤x≤1, 0≤y≤1, 0≤z≤1, 0≤p≤1, x+y+z+p=1 (NCMA); LiNiMnCoO₂; Li₂FeₓM₁₋ₓPO₄, where M is Mn and/or Ni, 0≤x≤1; LiMn₂O₄(LMO); LiFeSiO₄; LiNi_{0.6}Mn_{0.2}Co_{0.2}O₂(NMC622), LiMnO₂, LiNi_{0.5},Mn_{1.5}O₄, LiV₂(PO₄)₃, activated carbon, sulfur, and a combination thereof.

In yet another exemplary embodiment, the electrolyte composition may include 0.1 to 0.7 weight percent of the lithium 4,5-dicyano-2-(trifluoromethyl)imidazolide, lithium 4,5-dicyano-2-(pentafluoroethyl)imidazolide lithium 4,5-dicyano-2-(n-heptafluoropropyl)imidazolide), or the combination thereof, based on the total weight of the electrolyte composition; the lithium salt may include lithium hexafluorophosphate; and the organic solvent may include 0.5 to 3 moles of the lithium hexafluorophosphate per 1 liter of the organic solvent; and ethylene carbonate and dimethyl carbonate in a volume ratio of 1:4 to 1:1.

In yet another exemplary embodiment, the electrolyte composition may further include 1 to 10 weight percent of fluoroethylene carbonate, based on the total weight of the electrolyte composition; and 0.5 to 10 weight percent of vinylene carbonate, based on the total weight of the electrolyte composition.

In one exemplary embodiment, the present disclosure provides a device including an output component; and a battery configured for providing electrical energy to the device, the battery including an anode; a cathode; and an electrolyte composition including a lithium salt dissolved in an organic solvent; and 0.01 to less than 1 weight percent of lithium 4,5-dicyano-2-(trifluoromethyl)imidazolide, lithium 4,5-dicyano-2-(pentafluoroethyl)imidazolide lithium 4,5-dicyano-2-(n-heptafluoropropyl)imidazolide), or a combination thereof, based on a total weight of the electrolyte composition.

In addition to one or more of the features described herein, the electrolyte composition may include 0.1 to 0.7 weight percent of the lithium 4,5-dicyano-2-(trifluoromethyl)imidazolide, lithium 4,5-dicyano-2-(pentafluoroethyl)imidazolide lithium 4,5-dicyano-2-(n-heptafluoropropyl)imidazolide), or the combination thereof, based on the total weight of the electrolyte composition; the lithium salt may include lithium hexafluorophosphate; and the organic solvent may include 0.5 to 3 moles of the lithium hexafluorophosphate per 1 liter of the organic solvent; and ethylene carbonate and dimethyl carbonate in a volume ratio of 1:4 to 1:1.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 schematically illustrates an exemplary battery including the disclosed electrolyte composition, in accordance with the present disclosure;

FIG. 2 schematically illustrates an exemplary device embodied by a vehicle equipped with the battery of FIG. 1, in accordance with the present disclosure;

FIG. 3 is a graph illustrating exemplary test results of a relationship between capacity retention of a battery and a number of operation cycles through which the battery is operated for a plurality of electrolyte compositions, in accordance with the present disclosure;

FIG. 4 is a graph illustrating exemplary test results of a relationship between specific capacity retention of a battery and a number of operation cycles through which the battery is operated for a plurality of electrolyte compositions, in accordance with the present disclosure; and

FIG. 5 is a graph illustrating exemplary test results of a relationship between specific capacity of a battery and a number of operation cycles through which the battery is operated for a plurality of electrolyte compositions, in accordance with the present disclosure.

### DETAILED DESCRIPTION

The following description is merely exemplary in nature and is not intended to limit the present disclosure, its application or uses. It should be understood that throughout the drawings, corresponding reference numerals indicate like or corresponding parts and features.

During operation of a battery, chemical reactions taking place between the anode and the electrolyte composition cause a solid electrolyte interphase (SEI) layer to be formed upon an anode. Similarly, chemical reactions taking place between the cathode and the electrolyte composition cause a cathode electrolyte interphase (CEI) layer to be formed upon a cathode. The SEI layer and the CEI layer form as films upon the anode and cathode, respectively.

Increased stability in the SEI layer and the CEI layer may provide excellent useful life or increased electrode capacity retention in the anode and cathode, respectively.

Electrolyte compositions including lithium hexafluorophosphate (LiPF₆) in use within a battery may develop reactive species, such as hydrofluoric acid (HF). HF may interfere with interfacial structures of electrodes and cause degradation of the electrode surface that may contribute to capacity reduction over multiple operation cycles of the battery.

A cathode may include nickel and may include manganese. Over multiple operation cycles of the battery, nickel and manganese may suffer from dissolution or may leach out of the cathode, thereby contributing to capacity reduction of the battery.

Nickel-rich cathodes such as nickel-cobalt-manganese-aluminum (NCMA) may be moisture sensitive. Provided is an electrolyte composition including lithium 4,5-dicyano-2-(trifluoromethyl)imidazolide, lithium 4,5-dicyano-2-(pentafluoroethyl)imidazolide lithium 4,5-dicyano-2-(n-heptafluoropropyl)imidazolide), or a combination thereof.

The lithium 4,5-dicyano-2-(trifluoromethyl)imidazolide, lithium 4,5-dicyano-2-(pentafluoroethyl)imidazolide lithium 4,5-dicyano-2-(n-heptafluoropropyl)imidazolide), or the combination thereof may not only suppress hydrolysis of LiPF₆ to form HF, but may also improve electrochemical performance for cells including a nickel-rich cathode (e.g., a cathode including greater than 50 weight percent of nickel) and an anode including silicon. Presence of lithium 4,5-dicyano-2-(trifluoromethyl)imidazolide, lithium 4,5-dicyano-2-(pentafluoroethyl)imidazolide lithium 4,5-dicyano-2-(n-heptafluoropropyl)imidazolide), or a combination thereof in the disclosed concentration range may reduce presence of HF in the electrolyte composition by suppressing hydrolysis of LiPF₆.

The lithium 4,5-dicyano-2-(trifluoromethyl)imidazolide, lithium 4,5-dicyano-2-(pentafluoroethyl)imidazolide lithium 4,5-dicyano-2-(n-heptafluoropropyl)imidazolide), or the combination thereof can provide performance improvement at relatively low concentration (for example, less than 1% or 0.1 to 0.7%). The lithium 4,5-dicyano-2-(trifluoromethyl)imidazolide, lithium 4,5-dicyano-2-(pentafluoroethyl)imidazolide lithium 4,5-dicyano-2-(n-heptafluoropropyl)imidazolide), or the combination thereof can provide performance improvement at such concentration in a cell including an anode including silicon, for example, a cell including an anode including lithium-doped silicon oxide and graphite and a cathode including NCMA.

The disclosed electrolyte composition may provide excellent cycle life for a battery. The battery may include an anode including silicon and a cathode including nickel, for example, a nickel-rich cathode. The disclosed electrolyte composition including lithium 4,5-dicyano-2-(trifluoromethyl)imidazolide, lithium 4,5-dicyano-2-(pentafluoroethyl)imidazolide lithium 4,5-dicyano-2-(n-heptafluoropropyl)imidazolide), or a combination thereof may help contribute to excellent cycle performance and capacity retention. Including fluoroethylene carbonate (FEC) and vinylene carbonate (VC) in the electrolyte composition may help further contribute to excellent cycle performance and capacity retention.

The electrolyte composition includes 0.01 to less than 1 weight percent of lithium 4,5-dicyano-2-(trifluoromethyl)imidazolide, lithium 4,5-dicyano-2-(pentafluoroethyl)imidazolide lithium 4,5-dicyano-2-(n-heptafluoropropyl)imidazolide), or a combination thereof, based on a total weight of the electrolyte composition. The electrolyte composition may include 0.01 to 0.7 weight percent, 0.1 to 0.7 weight percent, or 0.1 to 0.5 weight percent of lithium 4,5-dicyano-2-(trifluoromethyl)imidazolide, lithium 4,5-dicyano-2-(pentafluoroethyl)imidazolide lithium 4,5-dicyano-2-(n-heptafluoropropyl)imidazolide), or a combination thereof, based on a total weight of the electrolyte composition.

The electrolyte composition may include 1 to 10 weight percent, or 1 to 5 weight percent, of fluoroethylene carbonate, based on a total weight of the electrolyte composition. The electrolyte composition may include 0.5 to 10 weight percent, or 0.5 to 5 weight percent, of vinylene carbonate, based on a total weight of the electrolyte composition.

An electrolyte composition for a battery is provided. The electrolyte composition includes a lithium salt dissolved in an organic solvent or a mixture of organic solvents.

Appropriate lithium salts may have inert anions. Exemplary lithium salts that may be dissolved in an organic solvent or a mixture of organic solvents include lithium hexafluorophosphate (LiPF₆), lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium difluorooxalatoborate (LiBF₂(C₂O₄)) (LiODFB), lithium tetraphenylborate (LiB(C₆H₅)₄), lithium bis-(oxalate)borate (LiB(C₂O₄)₂) (LiBOB), lithium tetrafluorooxalatophosphate (LiPF₄(C₂O₄)) (LiFOP), lithium nitrate (LiNO₃), lithium hexafluoroarsenate (LiAsF₆), lithium trifluoromethanesulfonate (LiCF₃SO₃), lithium bis(trifluoromethanesulfonimide) (LiTFSI) (LiN(CF₃SO₂)₂), lithium fluorosulfonylimide (LiN(FSO₂)₂) (LiFSI), lithium fluoroalkylphosphate (LiFAP) (Li₃O₄P), or a combination thereof.

The lithium salt may be dissolved in a variety of organic solvents, including, for example, an alkyl carbonate, such as a cyclic carbonate (e.g., ethylene carbonate (EC), propylene carbonate (PC), butylene carbonate (BC), fluoroethylene carbonate (FEC)), a linear carbonate (e.g., dimethyl carbonate (DMC), diethyl carbonate (DEC), ethyl methyl carbonate (EMC)), an aliphatic carboxylic ester (e.g., methyl formate, methyl acetate, methyl propionate), a γ-lactone (e.g., γ-butyrolactone, γ-valerolactone), a chain structure ether (e.g., 1,2-dimethoxyethane (DME), 1-2-diethoxyethane, ethoxymethoxyethane), a cyclic ether (e.g., tetrahydrofuran, 2-methyltetrahydrofuran, 1,3-dioxolane (DOL)), a sulfur compound (e.g., sulfolane), or a combination thereof. The electrolytic material may include from 0.5 to 3 moles per liter (molar (M)) of lithium salt. When the electrolytic material has a lithium concentration greater than 2 M or ionic liquids, the electrolytic material may include a diluter, such as fluoroethylene carbonate (FEC), hydrofluoroether (HFE), or a combination thereof.

The lithium salt may include lithium hexafluorophosphate, which may be present in an amount of 0.5 to 3 moles per 1 liter of the organic solvent. The organic solvent may include ethylene carbonate and dimethyl carbonate in a volume ratio of 1:4 to 1:1.

The disclosed electrolyte composition may be utilized with a variety of battery configurations. The anode of the battery may include silicon, for example, including silicon (Si), silicon monoxide (SiO), modified silicon/silicon monoxide (Si/SiO) (i.e., carbon coated Si/SiO), a silicon-carbon compound (Si/C), or a combination thereof. The anode may include silicon, silicon monoxide (SiO), a lithium-doped silicon oxide (LiₓSiOₓ) such as a lithium-doped silicon monoxide (LiₓSiO), Si/C, or a combination thereof. The anode may further include graphite.

The cathode of the battery may include nickel, for example, the cathode may be a nickel-rich cathode (e.g., including relatively high levels of nickel).

The anode of the battery may include silicon, and the cathode of the battery may include nickel, for example, the cathode may be a nickel-rich cathode.

The positive electrode may include a layered lithium transitional metal oxide. For example, the positive electrode may include Li₍₁₊ₓ₎Mn₂O₄, where 0.1≤x≤1; LiMn₍₂₋ₓ₎NiₓO₄, where 0≤x≤0.5; LiCoO₂; Li(NiₓMn_{y}Co_{z})O₂, where 0≤x≤1, 0≤y≤1, 0≤z≤1, and x+y+z=1; LiNi_{(1-x-y)}CoₓM_{y}O₂, where 0<x<0.2, y<0.2, and M is Al, Mg, or Ti; LiFePO₄, LiMn₂₋ₓFeₓPO₄, where 0<x<0.3; LiNiCoAlO₂; LiMPO₄, where M is at least one of Fe, Ni, Co, and Mn; Li(NiₓMn_{y}Co_{z}Alₚ)O₂, where 0≤x≤1, 0≤y≤1, 0≤z≤1, 0≤p≤1, x+y+z+p=1 (NCMA); LiNiMnCoO₂; Li₂FeₓM₁₋ₓPO₄ (M=Mn and/or Ni, 0≤x≤1); LiMn₂O₄ (LMO); LiFeSiO₄; LiNi_{0.6}Mn_{0.2}Co_{0.2}O₂(NMC622), LiMnO₂, LiNi_{0.5},Mn_{1.5}O₄, LiV₂(PO₄)₃, activated carbon, sulfur (e.g., greater than 60 wt. % based on total weight of the positive electrode), or a combination thereof.

The disclosed electrolyte composition may be utilized in a wide variety of batteries, including, for example, lithium-ion, lithium-metal, and lithium sulfur/oxygen batteries.

A battery is provided. The battery includes an anode, a cathode, and the disclosed electrolyte composition. The electrolyte composition includes a lithium salt dissolved in an organic solvent. The electrolyte composition includes 0.01 to less than 1 weight percent of lithium 4,5-dicyano-2-(trifluoromethyl)imidazolide, lithium 4,5-dicyano-2-(pentafluoroethyl)imidazolide lithium 4,5-dicyano-2-(n-heptafluoropropyl)imidazolide), or a combination thereof, based on a total weight of the electrolyte composition.

A device is provided. The device includes an output component and a battery configured for providing electrical energy to the device. The battery includes an anode, a cathode, and the disclosed electrolyte composition. The electrolyte composition includes a lithium salt dissolved in an organic solvent. The electrolyte composition further includes 0.01 to less than 1 weight percent of lithium 4,5-dicyano-2-(trifluoromethyl)imidazolide, lithium 4,5-dicyano-2-(pentafluoroethyl)imidazolide lithium 4,5-dicyano-2-(n-heptafluoropropyl)imidazolide), or a combination thereof, based on a total weight of the electrolyte composition. The device may be a vehicle.

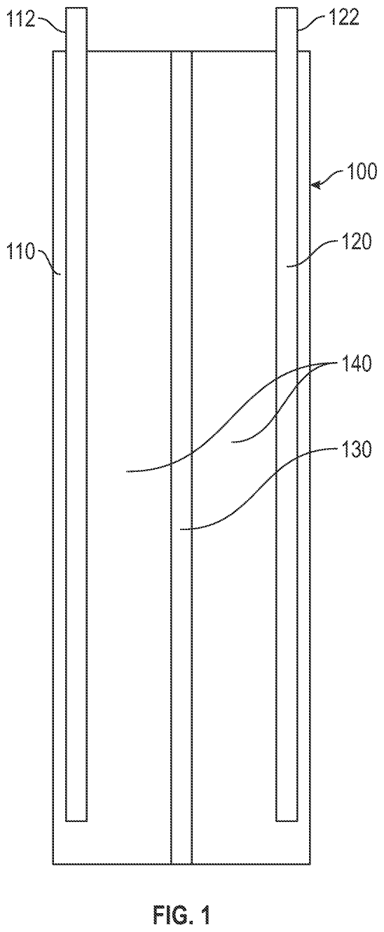

Referring now to the drawings, wherein like reference numbers refer to like features throughout the several views, FIG. 1 schematically illustrates an exemplary battery cell 100, including an anode 110, a cathode 120, a separator 130, and an electrolyte composition 140. The battery cell 100 enables converting electrical energy into stored chemical energy in a charging cycle, and the battery cell 100 enables converting stored chemical energy into electrical energy in a discharging cycle. A negative current collector 112 is illustrated connected to the anode 110, and a positive current collector 122 is illustrated connected to the cathode 120. The separator 130 is operable to separate the anode 110 from the cathode 120 and to enable ion transfer through the separator 130. The electrolyte composition 140 is a liquid or gel that provides a lithium-ion conduction path between the anode 110 and the cathode 120.

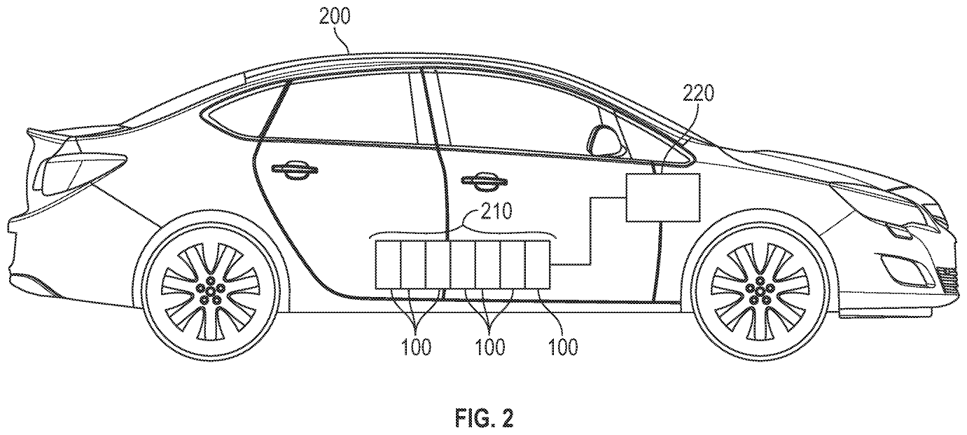

The battery cell 100 may be utilized in a wide range of applications and powertrains. FIG. 2 schematically illustrates an exemplary device 200 (e.g., a battery electric vehicle (BEV)), including a battery pack 210 that includes a plurality of battery cells 100. The plurality of battery cells 100 may be connected in various combinations, for example, with a portion being connected in parallel and a portion being connected in series, to achieve goals of supplying electrical energy at a desired voltage. The battery pack 210 is illustrated as electrically connected to a motor generator unit 220 useful to provide motive force to the vehicle 200. The motor generator unit 220 may include an output component, for example, an output shaft, which provides mechanical energy useful to provide the motive force to the vehicle 200. A number of variations to vehicle 200 are envisioned, and the disclosure is not intended to be limited to the examples provided.

Certain features of the current technology are further illustrated in the following non-limiting examples.

### EXAMPLES

### Comparative Example 1

The electrolyte composition of Comparative Example 1 included 1 mole per liter (molar (M)) lithium hexafluorophosphate (LiPF₆) in EC/DMC (volume ratio of EC:DMC of 3:7) and 2 weight percent FEC.

### Example 1

The electrolyte composition of Example 1 included 1 M LiPF6 in EC/DMC (volume ratio of EC:DMC of 3:7), 2 weight percent FEC, and 1 weight percent lithium 4,5-dicyano-2-(trifluoromethyl)imidazolide.

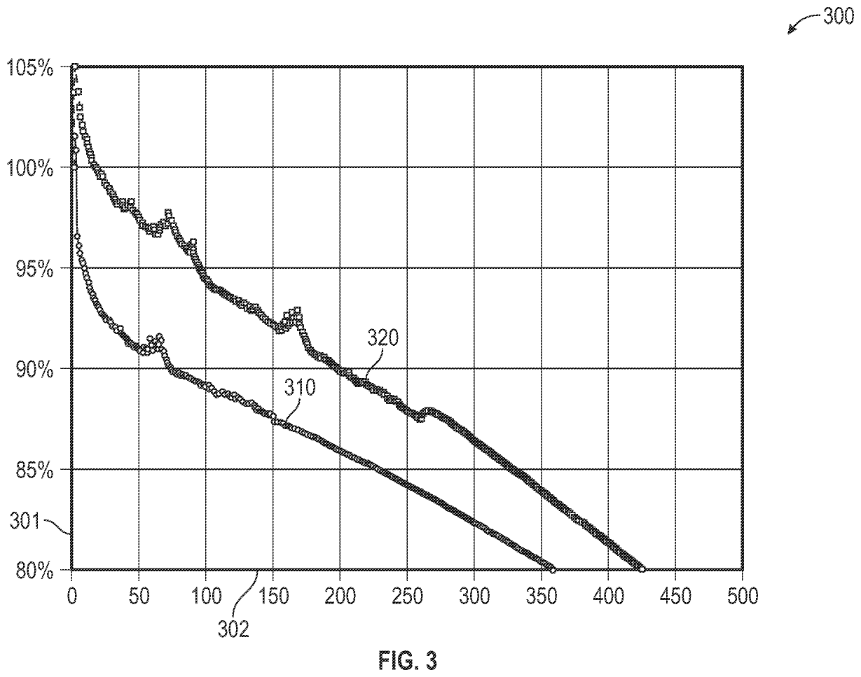

FIG. 3 is a graph 300 illustrating exemplary test results of a relationship between capacity retention of a battery and a number of operation cycles through which the battery is operated for a plurality of electrolyte compositions.

A vertical axis 301 is illustrated describing a capacity retention of the cell as a percentage of an original cell capacity. A horizontal axis 302 is illustrated describing the number of operation cycles. Plot 310 illustrates Comparative Example 1 and plot 320 illustrates Example 1. An improvement in battery capacity retention may be seen in plot 320, which shows an improvement in cell capacity retention as a result of an inclusion of lithium 4,5-dicyano-2-(trifluoromethyl)imidazolide.

### Comparative Example 2

The electrolyte composition of Comparative Example 1 included 1 M LiPF6 in EC/DMC (volume ratio of EC:DMC of 3:7).

### Comparative Example 3

The electrolyte composition of Comparative Example 2 included 1 M LiPF6 in EC/DMC (volume ratio of EC:DMC of 3:7) and 1 weight percent of lithium difluoro(oxalato)borate.

### Comparative Example 4

The electrolyte composition of Comparative Example 3 included 1 M LiPF6 in EC/DMC (volume ratio of EC:DMC of 3:7), 2 weight percent fluoroethylene carbonate (FEC), and 1 weight percent vinylene carbonate (VC).

### Example 2

The electrolyte composition of Example 1 included 1 M LiPF6 in EC/DMC (volume ratio of EC:DMC of 3:7), 2 weight percent FEC, 1 weight percent VC, and 0.1 weight percent lithium 4,5-dicyano-2-(trifluoromethyl)imidazolide.

### Example 3

The electrolyte composition of Example 2 included 1 M LiPF6 in EC/DMC (volume ratio of EC:DMC of 3:7), 2 weight percent FEC, 1 weight percent VC, and 0.5 weight percent lithium 4,5-dicyano-2-(trifluoromethyl)imidazolide.

### Example 4

The electrolyte composition of Example 3 included 1 M LiPF6 in EC/DMC (volume ratio of EC:DMC of 3:7), 2 weight percent FEC, 1 weight percent VC, and 1 weight percent lithium 4,5-dicyano-2-(trifluoromethyl)imidazolide.

Cells were formed with the electrolyte of each of Examples, an anode including 20 weight percent of LiSiOx-graphite, and a cathode including nickel-cobalt-manganese-aluminum (NCMA). Binders of the anode and cathode were carboxymethyl cellulose and polyvinylidene fluoride, respectively. Conductive additives were carbon black and carbon nanotubes. The separator was based on polypropylene and/or polyethylene.

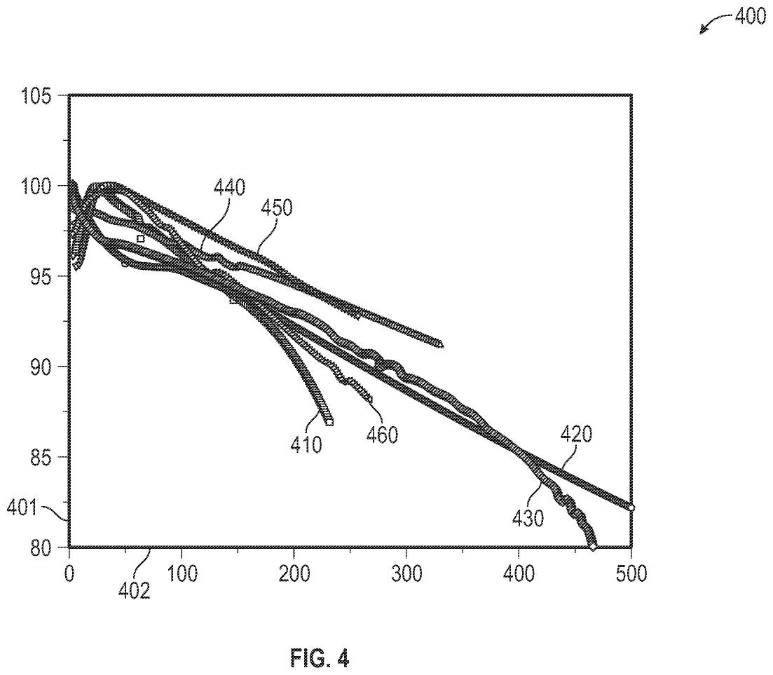

FIG. 4 is a graph 400 illustrating exemplary test results of a relationship between specific capacity retention of a battery and a number of operation cycles through which the battery is operated for a plurality of electrolyte compositions. A vertical axis 401 is illustrated describing a capacity retention of the cell as a percentage of an original cell capacity. A horizontal axis 402 is illustrated describing the number of operation cycles. Plot 410 illustrates Comparative Example 2, plot 420 illustrates Comparative Example 3, plot 430 illustrates Comparative Example 4, plot 440 illustrates Example 2, plot 450 illustrates Example 3, and plot 460 illustrates Example 4. An improvement in battery capacity retention may be seen in plots 440, 450, and 460, which show an improvement in cell capacity retention as a result of an inclusion of lithium 4,5-dicyano-2-(trifluoromethyl)imidazolide.

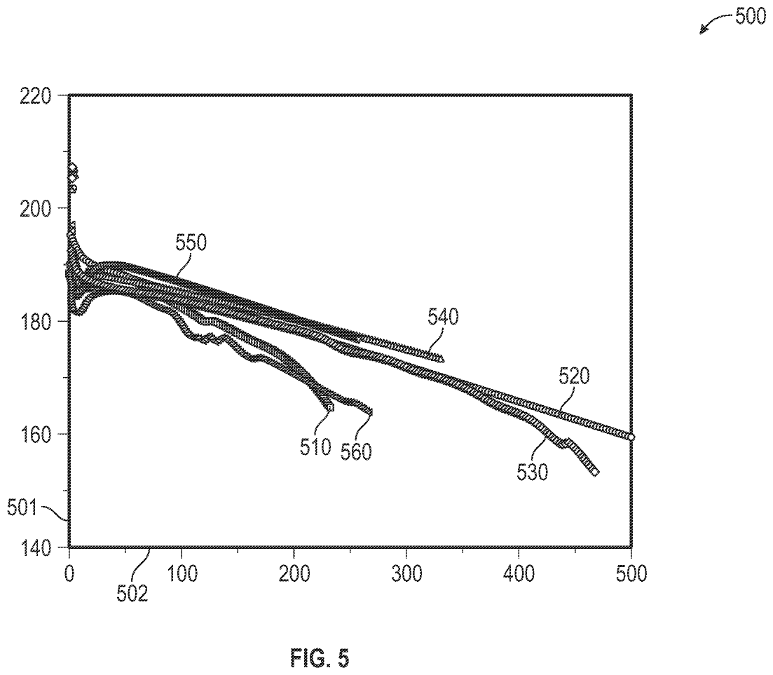

FIG. 5 is a graph 500 illustrating exemplary test results of a relationship between specific capacity of a battery and a number of operation cycles through which the battery is operated for a plurality of electrolyte compositions.

A vertical axis 501 is illustrated describing a specific capacity of the cell in milliampere hours per gram. A horizontal axis 502 is illustrated describing the number of operation cycles. Plot 510 illustrates Comparative Example 2, plot 520 illustrates Comparative Example 3, plot 530 illustrates Comparative Example 4, plot 540 illustrates Example 2, plot 550 illustrates Example 3, and plot 560 illustrates Example 4. An improvement in battery specific capacity retention may be seen in plots 540 and 550, which show an improvement in battery specific capacity as a result of an inclusion of 0.1 to 0.5 weight percent of lithium 4,5-dicyano-2-(trifluoromethyl)imidazolide, based on a total weight of the electrolyte composition.

With further reference to FIG. 5, inclusion of VC may help contribute to solid electrolyte interphase (SEI) stability with an anode including silicon. For an electrolyte including VC, inclusion of 0.1 to 0.5 weight percent of lithium 4,5-dicyano-2-(trifluoromethyl)imidazolide, based on a total weight of the electrolyte composition, may result in an improvement in battery specific capacity retention.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or base film is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. An electrolyte composition for a battery, the electrolyte composition comprising:
a lithium salt dissolved in an organic solvent; and
0.01 to less than 1 weight percent of lithium 4,5-dicyano-2-(trifluoromethyl)imidazolide, lithium 4,5-dicyano-2-(pentafluoroethyl)imidazolide lithium 4,5-dicyano-2-(n-heptafluoropropyl)imidazolide), or a combination thereof, based on a total weight of the electrolyte composition.

2. The electrolyte composition of claim 1, wherein the electrolyte composition comprises 0.1 to 0.7 weight percent of the lithium 4,5-dicyano-2-(trifluoromethyl)imidazolide, lithium 4,5-dicyano-2-(pentafluoroethyl)imidazolide lithium 4,5-dicyano-2-(n-heptafluoropropyl)imidazolide), or the combination thereof, based on the total weight of the electrolyte composition.

3. The electrolyte composition of claim 1, wherein the lithium salt comprises lithium hexafluorophosphate, lithium perchlorate, lithium tetrachloroaluminate, lithium iodide, lithium bromide, lithium thiocyanate, lithium tetrafluoroborate, lithium difluorooxalatoborate, lithium tetraphenylborate, lithium bis-(oxalate)borate, lithium tetrafluorooxalatophosphate, lithium nitrate, lithium hexafluoroarsenate, lithium trifluoromethanesulfonate, lithium bis(trifluoromethanesulfonimide), lithium fluorosulfonylimide, lithium fluoroalkylphosphate, or a combination thereof.

4. The electrolyte composition of claim 1, wherein the organic solvent comprises a cyclic carbonate, a linear carbonate, an aliphatic carboxylic ester, a γ-lactone, a chain structure ether, a cyclic ether, a sulfur compound, or a combination thereof.

5. The electrolyte composition of claim 1, wherein the organic solvent comprises:
ethylene carbonate, propylene carbonate, butylene carbonate, fluoroethylene carbonate, or a combination thereof; and
dimethyl carbonate, diethyl carbonate, ethyl methyl carbonate, or a combination thereof.

6. The electrolyte composition of claim 1, further comprising:
1 to 10 weight percent of fluoroethylene carbonate, based on the total weight of the electrolyte composition; and
0.5 to 10 weight percent of vinylene carbonate, based on the total weight of the electrolyte composition.

7. The electrolyte composition of claim 1, wherein the lithium salt comprises lithium hexafluorophosphate.

8. The electrolyte composition of claim 1, wherein the organic solvent comprises ethylene carbonate and dimethyl carbonate in a volume ratio of 1:4 to 1:1.

9. The electrolyte composition of claim 1, wherein:
the electrolyte composition comprises 0.1 to 0.7 weight percent of the lithium 4,5-dicyano-2-(trifluoromethyl)imidazolide, lithium 4,5-dicyano-2-(pentafluoroethyl)imidazolide lithium 4,5-dicyano-2-(n-heptafluoropropyl)imidazolide), or the combination thereof, based on the total weight of the electrolyte composition;
the lithium salt comprises lithium hexafluorophosphate; and
the organic solvent comprises
0.5 to 3 moles of the lithium hexafluorophosphate per 1 liter of the organic solvent, and
ethylene carbonate and dimethyl carbonate in a volume ratio of 1:4 to 1:1.

10. The electrolyte composition of claim 9, further comprising:
1 to 10 weight percent of fluoroethylene carbonate, based on the total weight of the electrolyte composition; and
0.5 to 10 weight percent of vinylene carbonate, based on the total weight of the electrolyte composition.

11. The electrolyte composition of claim 10, wherein:
the fluoroethylene carbonate is present in an amount of 1 to 5 weight percent, based on the total weight of the electrolyte composition; and
the vinylene carbonate is present in an amount of 0.5 to 5 weight percent, based on the total weight of the electrolyte composition.

12. A battery comprising:
an anode;
a cathode; and
an electrolyte composition comprising:
a lithium salt dissolved in an organic solvent, and
0.01 to less than 1 weight percent of lithium 4,5-dicyano-2-(trifluoromethyl)imidazolide, lithium 4,5-dicyano-2-(pentafluoroethyl)imidazolide lithium 4,5-dicyano-2-(n-heptafluoropropyl)imidazolide), or a combination thereof, based on a total weight of the electrolyte composition.

13. The battery of claim 12, wherein the anode comprises silicon.

14. The battery of claim 13, wherein the anode comprises silicon monoxide, a lithium-doped silicon monoxide, or a combination thereof.

15. The battery of claim 12, wherein the cathode comprises nickel.

16. The battery of claim 12, wherein the cathode comprises Li₍₁₊ₓ₎Mn₂O₄, where 0.1≤x≤1; LiMn₍₂₋ₓ₎NiₓO₄, where 0≤x≤0.5; LiCoO₂; Li(NiₓMn_{y}Co_{z})O₂, where 0≤x≤1, 0≤y≤1, 0≤z≤1, and x+y+z=1; LiNi_{(1-x-y)}CoₓM_{y}O₂, where 0<x<0.2, y<0.2, and M is Al, Mg, or Ti; LiFePO₄, LiMn₂₋ₓFeₓPO₄, where 0<x<0.3; LiNiCoAlO₂; LiMPO₄, where M is at least one of Fe, Ni, Co, and Mn; Li(NiₓMn_{y}Co_{z}Alₚ)O₂, where 0≤x≤1, 0≤y≤1, 0≤z≤1, 0≤p≤1, x+y+z+p=1 (NCMA); LiNiMnCoO₂; Li₂FeₓM₁₋ₓPO₄, where M is Mn and/or Ni, 0≤x≤1; LiMn₂O₄(LMO); LiFeSiO₄; LiNi_{0.6}Mn_{0.2}Co_{0.2}O₂(NMC622), LiMnO₂, LiNi_{0.5},Mn_{1.5}O₄, LiV₂(PO₄)₃, activated carbon, sulfur, and a combination thereof.

17. The battery of claim 12, wherein:
the electrolyte composition comprises 0.1 to 0.7 weight percent of the lithium 4,5-dicyano-2-(trifluoromethyl)imidazolide, lithium 4,5-dicyano-2-(pentafluoroethyl)imidazolide lithium 4,5-dicyano-2-(n-heptafluoropropyl)imidazolide), or the combination thereof, based on the total weight of the electrolyte composition;
the lithium salt comprises lithium hexafluorophosphate; and
the organic solvent comprises
0.5 to 3 moles of the lithium hexafluorophosphate per 1 liter of the organic solvent; and
ethylene carbonate and dimethyl carbonate in a volume ratio of 1:4 to 1:1.

18. The battery of claim 17, wherein the electrolyte composition further comprises:
1 to 10 weight percent of fluoroethylene carbonate, based on the total weight of the electrolyte composition; and
0.5 to 10 weight percent of vinylene carbonate, based on the total weight of the electrolyte composition.

19. A device comprising:
an output component; and
a battery configured for providing electrical energy to the device, the battery comprising:
an anode;
a cathode; and
an electrolyte composition comprising:
a lithium salt dissolved in an organic solvent; and
0.01 to less than 1 weight percent of lithium 4,5-dicyano-2-(trifluoromethyl)imidazolide, lithium 4,5-dicyano-2-(pentafluoroethyl)imidazolide lithium 4,5-dicyano-2-(n-heptafluoropropyl)imidazolide), or a combination thereof, based on a total weight of the electrolyte composition.

20. The device of claim 19, wherein:
the electrolyte composition comprises 0.1 to 0.7 weight percent of the lithium 4,5-dicyano-2-(trifluoromethyl)imidazolide, lithium 4,5-dicyano-2-(pentafluoroethyl)imidazolide lithium 4,5-dicyano-2-(n-heptafluoropropyl)imidazolide), or the combination thereof, based on the total weight of the electrolyte composition;
the lithium salt comprises lithium hexafluorophosphate; and
the organic solvent comprises
0.5 to 3 moles of the lithium hexafluorophosphate per 1 liter of the organic solvent; and
ethylene carbonate and dimethyl carbonate in a volume ratio of 1:4 to 1:1.
